(19) United States
(12) Patent Application Publication
(10) Pub. No.: US 2014/0129511 A1
(43) Pub. Date: May 8, 2014

(54) ON-DEMAND VIEWING OF A REPORT WITH SECURITY PERMISSIONS

(71) Applicant: MICROSOFT CORPORATION, Redmond, WA (US)

(72) Inventors: Paul Roger Bramel, Fargo, ND (US); Jill Suzanne Carter, Fargo, ND (US); Theodore John Cihak, Detroit Lakes, MN (US); Michael Vernon Lee, Fargo, ND (US)

(73) Assignee: Microsoft Corporation, Redmond, WA (US)

(21) Appl. No.: 13/669,457

(22) Filed: Nov. 6, 2012

(51) Int. Cl. G06F 17/30

(52) U.S. Cl. 707/600

(57) ABSTRACT

A report link with security permissions is provided that generates a report personalized to a user's security permissions on-demand. A report service providing the functionality of a business intelligence system can create a uniform resource locator (URL) for a report. The URL may be generated to reference an application server, a report name, and a report identifier. An output file type can be passed through the URL to indicate how the report is to be viewed. A same report link may be distributed to users having different security permissions, while being used to render different viewable reports according to each user's permissions. When a client requests a report located at the URL, the report service performs a check of the roles/permissions of the user and arranges the report view for the user by combining sections of the report snapshot according to the roles/permissions of the client.

### BACKGROUND

A reporting tool is a business intelligence (BI) tool providing a graphical user interface (GUI) that enables users to view, create and schedule reports on business records and other data stored in database or data warehouse. BI refers to the processes, methodologies, and technologies used for collecting, analyzing, and presenting business information in order to support users in making better business decisions.

A report that is generated and distributed using a reporting or other business intelligence tool may have different intended audiences. Each of those different intended audiences may be interested in, or be permitted to access, different information. Currently, in a reporting and business intelligence tool, multiple reports would be generated in order to obtain a specific report directed to a corresponding consumer. The need to generate and distribute multiple reports in order to provide the appropriate information to the corresponding consumers can be inefficient and can even introduce errors when manually generating reports multiple times with different settings.

### BRIEF SUMMARY

Methods and systems providing an on-demand personalized report based on a user's security permissions are disclosed. In some embodiments, a report generation and distribution system utilizing a report service is provided. The report service can be used to present a personalized view of a report according to a user's security permissions. The report service can also create a report link, specifying a uniform resource locator (URL) that can be used to distribute a generated report.

A personalized view of a report based on folder and unit security of a database and/or BI tool can be distributed through providing a report link which a user can open in a program that meets their reporting needs. In accordance with certain embodiments, each report is personalized to a user at the time of viewing by checking the user's permissions and roles and populating a report according to those permissions and roles for display to the user. In a further embodiment, a personalized output option is provided to the user from which the user may select the format of the report.

In certain embodiments, the generated report can be administered and viewed via a web-browser interface or a report server viewer interface. A user may click on a report link URL created by the report service and optionally view a page or menu associated with the link that enables the user to select a particular output type for the report. In response to receiving a selection of the output type from the user (or simply upon the request for a report at the URL where a default output type is associated with the report link), a personalized report can be generated and output for display to the user through the web-browser or report server viewer interface or as a report file.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIGS. 1A and 1B show an operating environment in which embodiments of the invention may be practiced.

FIG. 2 shows a process flow in accordance with an embodiment of the invention.

FIG. 3 shows a process flow in accordance with another embodiment of the invention.

FIG. 4 shows a flow diagram illustrating aspects of a method of providing a report via a report link in accordance with an embodiment of the invention.

FIG. 5 shows a representative screen shot of permissions applied to a library of a report GUI according to an example embodiment.

FIG. 6 illustrates permissions for units of a report according to an example embodiment.

FIG. 7A shows an example screen of a page presented to a user after clicking on or entering the report link into a web browser application in accordance with an embodiment of the invention.

FIG. 7B shows an example screen of a page presented to a user after clicking on or entering the report link into a web browser application in accordance with another embodiment of the invention.

FIGS. 8A and 8B show a personalized view of a report that has been opened in the XPS viewer in accordance with an embodiment of the invention.

FIG. 9 shows a block diagram illustrating components of a computing device used in some embodiments.

### DETAILED DESCRIPTION

Methods and systems providing an on-demand personalized report based on a user's security permissions are disclosed. According to embodiments of the invention, content of a report is personalized based on a user's security permissions. In accordance with embodiments of the invention, the customization, in which data of a report is filtered for a specific user, is postponed until the viewing stage. That is, according to embodiments of the invention, the filtering of data for populating a report is performed at a time that a user requests to view the report instead of at the time the report is generated.

In some embodiments, a report generation and distribution system utilizing a report service is provided. The report service can be used to access functionality of a report server, publisher, or other business intelligence server to present a personalized view of a report according to a user's security permissions. The report service can also create a report link, specifying a uniform resource locator (URL) that can be used to distribute a generated report.

The report service can be a web service in which company data can be accessed, analyzed, and presented. Accordingly, “report service” and “report server web service” may be used interchangeably herein.

A web service is a software system that supports interoperable machine-to-machine interaction over a network and enables software to connect to other software applications. A web service provides a collection of technological standards and protocols. The web service provides functions that may be implemented by a software or hardware agent that sends and receives messages (e.g., the computing platforms requesting and providing a particular service). According to embodiments, the report service can be embodied on one or more servers and access one or more databases and/or data warehouses.

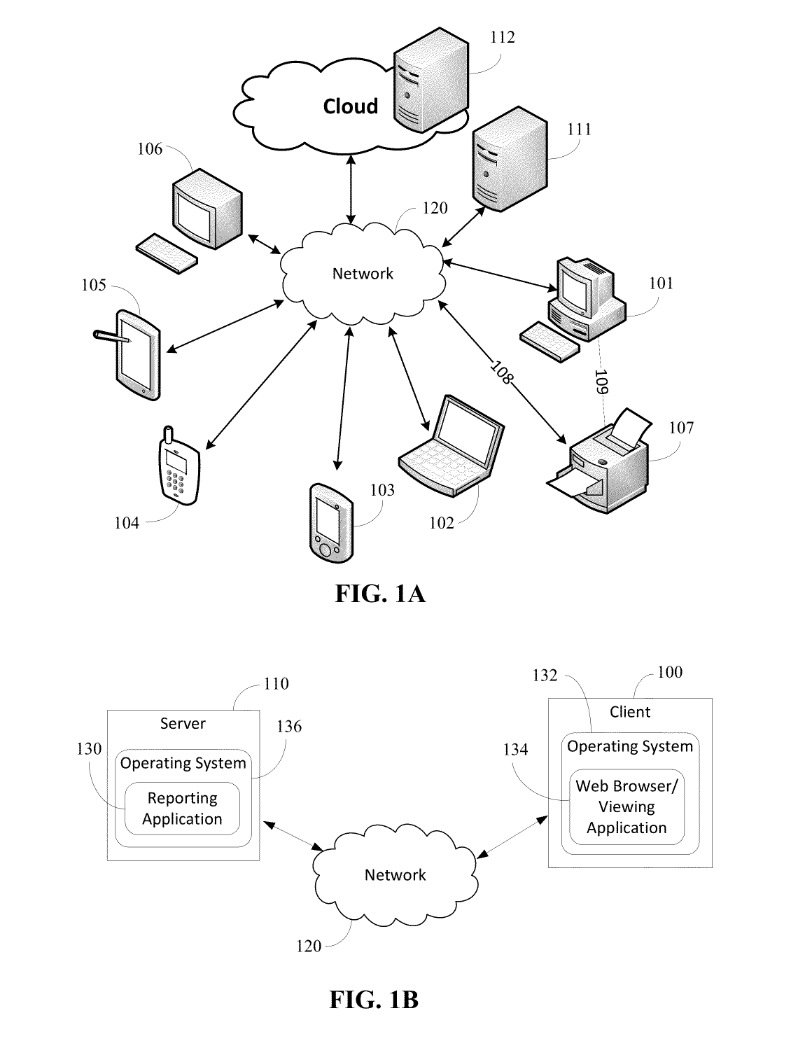

FIGS. 1A and 1B show an operating environment in which embodiments of the invention may be practiced. Referring to FIGS. 1A and 1B, a client device 100, including, but not limited to, a personal computer 101, laptop 102, personal digital assistant (PDA) 103, mobile phone (or smart phone) 104, tablet 105, or terminal 106, may be used to access a server 110 over a network 120. The server 110 may be an enterprise server 111 or a cloud-based server 112 on which a reporting application 130, or other business intelligence (BI) tool, is run. One or more databases (not shown) or data warehouses (not shown) may be connected to the report server 110.

In some embodiments, the server 110 is configured to execute the reporting application 130 and the client device 100 is configured to access the server computer 110 to interact with the server reporting application 130 in a client/server configuration.

Communication between computing devices in a client-server relationship may be initiated by a client sending a request to the server asking for access to a particular resource or for particular work to be performed. The server may subsequently perform the actions requested and send a response back to the client. The interaction between the client and the server may be facilitated by a web service.

The client device 100 is configured to execute an operating system 132 and one or more application programs such as, in the illustrated embodiment, a web browser (or viewing) application 134, and/or one or more other applications.

The report server 110 is configured to execute a server operating system 136, one or more application programs such as a reporting application 130, and/or one or more other applications. The server 110 can access one or more databases or data warehouses (not shown).

The operating system 132 is a computer program for controlling the operation of the client computing device 100. The application programs are executable programs configured to execute on top of the operating system 111 to provide various functionality such as described herein. The web browser application 134 is an application program for retrieving and traversing information resources on the World Wide Web (“the Web”), as well as resources provided by web servers in private networks via the network 120, and presenting the information resources to a user (e.g., rendering for display). Moreover, the web browser application 134 allows a user to access information and various functions provided by a server.

The server operating system 136 is a computer program for controlling the operation of the server computing device 110, and the application programs are executable programs configured to execute on top of the server operating system 136 to provide various functionality described herein.

The reporting application 130 can be a business intelligence (BI) tool providing a graphical user interface (GUI) that enables users to view, create and schedule reports on business records and other data stored in database or data warehouse. The reporting application can be associated with a database management system such as, for example, MICROSOFT SQL SERVER, a trademark of Microsoft Corp. Other embodiments may be applicable to IBM COGNOS business intelligence software, a registered trademark of International Business Machines Corp., and ORACLE FUSION MIDDLEWARE or ORACLE FUSION FINANCIALS, registered trademarks of Oracle and/or its affiliates.

The report server web service may be implemented as an Extensible Markup Language (XML) Web service with a Simple Object Access Protocol (SOAP) application programming interface (API) or a Windows Communication Foundation (WCF) Web hypertext transfer protocol (HTTP) service (with or without Secure Sockets Layer (SSL)).

For embodiments implemented as a WCF Web HTTP service, a report is exported to a file and returned as an inline attachment. The service can also set a content type (e.g. multipurpose Internet Mail Extensions (MIME)) in order for the report to open in an associated viewer application such as a client web browser application 134.

According to certain embodiments, a file report link uniform resource locator (URL) can be created. The URL that returns a latest version of a report may include a web service file reference such as “http://ReportServer/report.svc/latest//” and includes an application server (name and port), a globalized unique identifier (GUID) for the report identifier, and an output file type such as XLS (a file format associated with EXCEL, a registered trademark of Microsoft Corp.), XPS (an XML paper specification file), portable document format (PDF), comma separated value (CSV), hypertext markup language (HTML), cascading tile sheets (CSS), extensible business reporting language (XBRL), open data protocol (OData), and the like. For example, a file report link can be: “http://MyAppServer/report.svc/latest/XXXXXXXX-XXXX-XXXX-XXXX-XXXXXXXXXXXX/EXCEL”. By accessing the URL via, for example a GET HTTP request, a report may be obtained.

Security can be role-based and may be assigned to an individual item (e.g., a report or data source), a folder of items, or site wide.

The report server web service can involve authentication and impersonation. Authentication refers to a process by which an existing identity store, such as a corporate Active Directory, is used to access resources. Access to requested files and folders can be controlled based on the request URL (and a configuration file indicates users and groups of users that should have access to requested resources), file authorization, and/or role checks (using authorization logic and a role manager).

Impersonation refers to the ability of a thread to execute using different security information than the process that owns the thread. For example, a client may own a thread, but a server application can impersonate the client in order to execute the thread. This allows the server thread to act on behalf of that client to access objects on the server or validate access to the client's own objects.

In accordance with certain embodiments of the invention, the network 120 may be an internet, an intranet, or an extranet, and can be any suitable communications network including, but not limited to, a cellular (e.g., wireless phone) network, the Internet, a local area network (LAN), a wide area network (WAN), a WiFi network, an ad hoc network or a combination thereofuch networks may involve connections of network elements, such as hubs, bridges, routers, switches, servers, and gateways.

The network 120 may include one or more connected networks (e.g., a multi-network environment) including public networks, such as the Internet, and/or private networks such as a secure enterprise private network. Access to the network 120 may be provided via one or more wired or wireless access networks (not shown), as will be understood by those skilled in the art. As will also be appreciated by those skilled in the art, communication networks can take several different forms and can use several different communication protocols.

The client(s) 100 and the server(s) 110 can involve computing systems configured with one or more central processing units (CPUs), memory, mass storage, and I/O devices (e.g., network interface, user input device). Elements of the computing system can communicate with each other via a bus. The hardware platform of computing systems can be embodied in many forms including but not limited to, a personal computer, a server computer, a hand-held or laptop device, a multiprocessor system, a microprocessor-based system, programmable consumer electronics, and a distributed computing environment that includes any of the above systems or devices.

In certain embodiments, the client 100 can be embodied as a computing device including, but not limited to, a personal (desktop) computer 101, a laptop (or notebook or netbook) computer 102, a PDA 103, a mobile phone 104, a tablet 105, a gaming device or console (not shown), a user terminal 106, or a smart television (not shown). A printer 107 may be connected (via 108) to the server(s) 110 over the network 120 and/or may be connected (via 109) wired or wirelessly to the client, such as computer 101.

In certain embodiments, the server(s) 110, such as enterprise server 111 or cloud server 112, can be embodied as a computing device including, but not limited to, a server computer, an enterprise computer, a personal computer, a multiprocessor system, a microprocessor-based system, and a combination thereof.

It should be understood that the listing of client computing devices and the server computing devices is not intended to be limiting and that the client and server may be embodied in the same or different form and include physical and/or virtual components.

Although the cloud server 112 and network 120 are illustrated as separate entities in FIG. 1A, it should be understood that the distinction is merely to emphasize the use of a cloud-based service (which may be implemented in a distributed environment) as compared to a server that may be connected via a public or private network. The cloud based report server 112 may be implemented using one or more physical and/or virtual servers communicating over network 120.

It should be understood that multiple client computing devices, multiple networks, and/or multiple servers may be included as part of the operating environment.

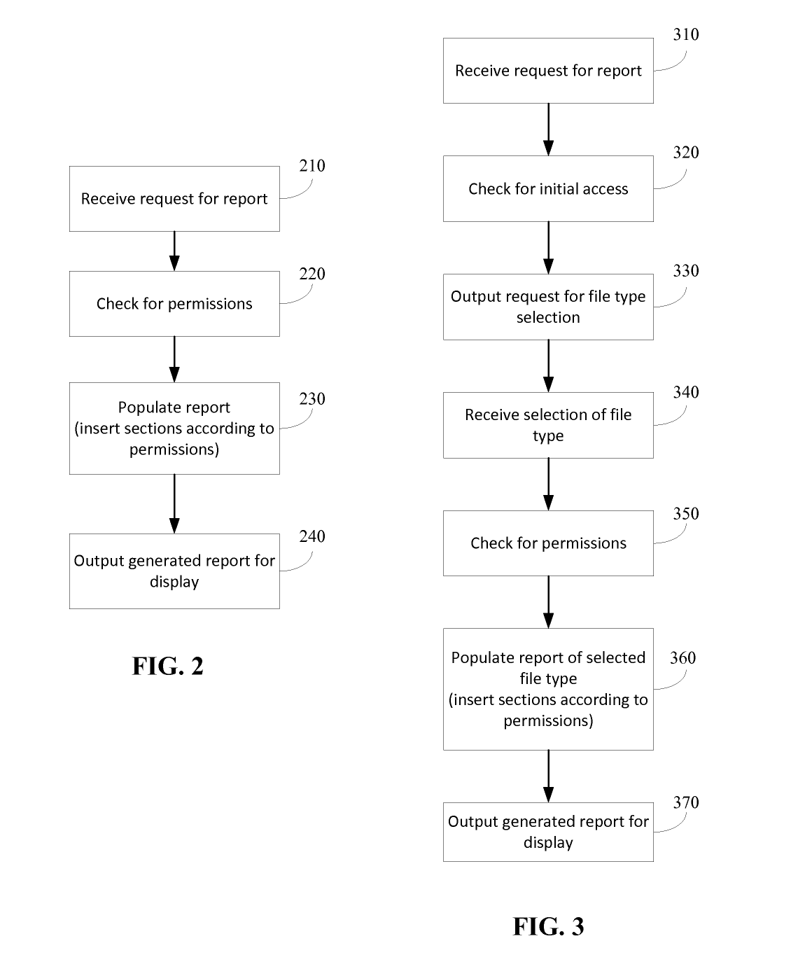

FIG. 2 shows a process flow in accordance with an embodiment of the invention. As shown in FIG. 2, a system for providing an on-demand personalized report based on a user's security permissions can receive a request for a report (210). The report request may be carried out by a web browser on a client device upon a user opening a report link (e.g., a URL of the report). A report server endpoint may facilitate the report request at the server side.

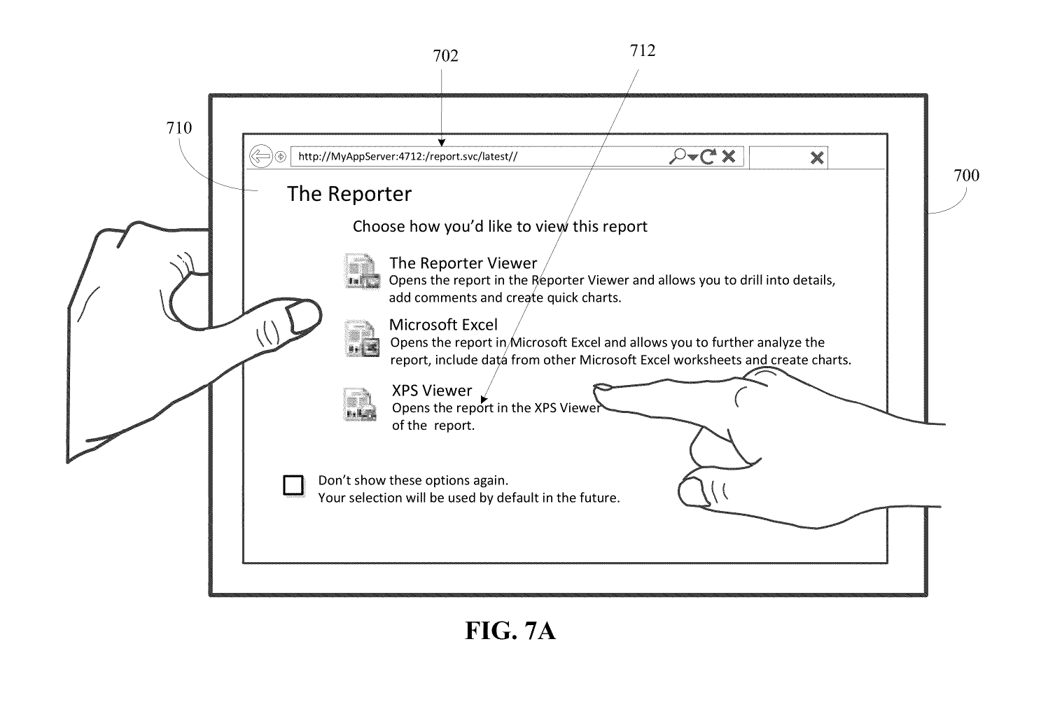

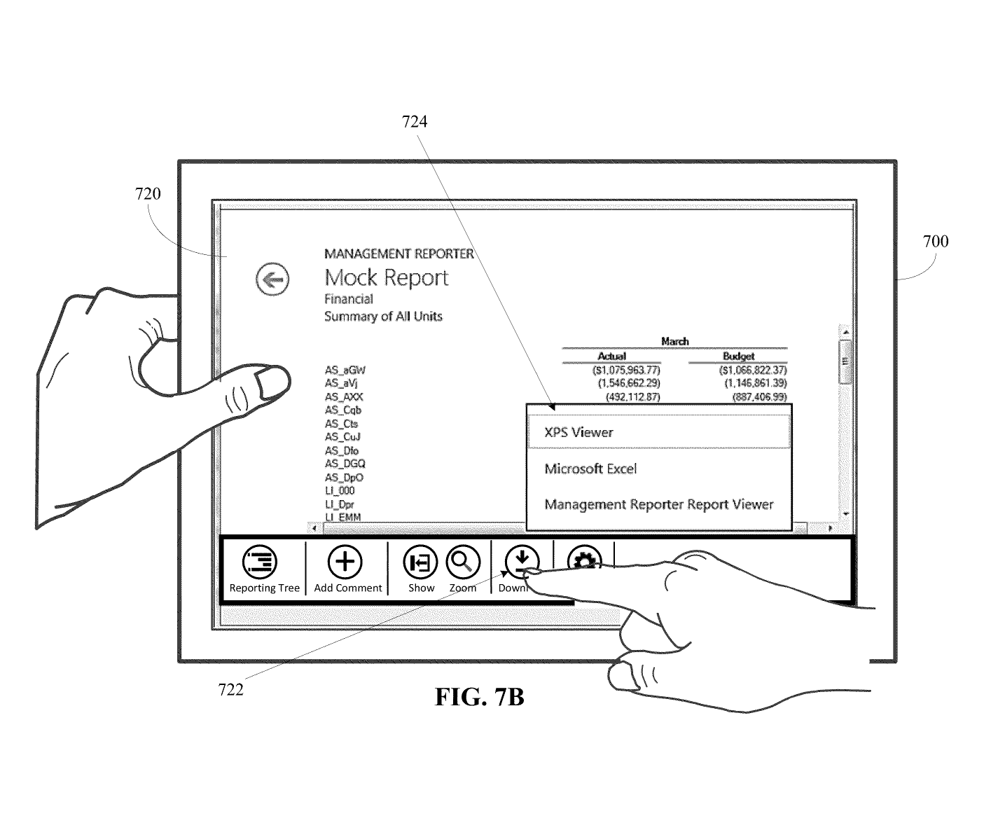

In order for the personalized report to be provided to the user, the system checks the permissions associated with the user (220). For example, the checking can be performed by an authorization method managed at the server endpoint. Based on the permissions, a report view can be populated by inserting sections that are specified by the user's permissions into an appropriate format type (230). The personalized report can be output for display to the user's device (240). For example, markup for a page (e.g., in HTML) can be sent to a user's device to be rendered via the web browser (see also for example FIG. 7B). In addition to being output for display, the report view may be printed, analyzed, and/or acted upon by the user in any suitable manner.

FIG. 3 shows a process flow in accordance with another embodiment of the invention in which a user is able to select the form in which the report is shown. Similarly to the process described with respect to FIG. 2, the system can receive a request for a report (310) from a user who performs, for example, via a browser application, a web request of the server at the URL of the report. The system can then perform an initial check (320) to determine whether the user is permitted to access the report. The system can present options for a user to select a file type, providing the user with flexibility as to how the report would be viewed (330). The selection of file type by a user (340) can append a file extension to the URL.

After receiving file type selection (340), the system can then check the permissions associated with the user (350). Based on the permissions and the selected file type, a report can be populated for viewing by inserting sections that are specified by the user's permissions into a format type corresponding to the selected file type (360). The personalized report can be output for display to the user's device (370).

In accordance with embodiments of the invention, a personalized report view is provided to users based on security permission access. A report link (URL) to a report can be created when the system is generating a report; and, once the link is distributed to various users of the system, a user who selects to open the link may be presented with a choice whether to open a file or launch a native viewer for viewing the report. If the user choses to open the file, the service returns a stream of data (the “file”) with a format as indicated by the user's selection. This file can be viewed in an associated viewer application for the file type, for example in EXCEL or XPS.

When using the native viewer associated with the reporting application, the HTML link is presented as custom protocol instead of the URL as provided for the other formats. For example, instead of an “http” protocol, a “mr” protocol or other custom application protocol may be used. Generally, the native viewer and its associated protocol handler have been installed on the user's computer in order for the native view selection to be effective.

A “native” viewer refers to a viewer that can display or appear to display a document or data in a format or file type associated with the program from which it is created. For example, where MICROSOFT MANAGEMENT REPORTER, a trademark of Microsoft Corp., is used as the reporting application, the native viewer can present the report in a form that maintains the functionality of the MICROSOFT DYNAMICS Enterprise Resource Planning (ERP) business solution software, a registered trademark of Microsoft Corp.

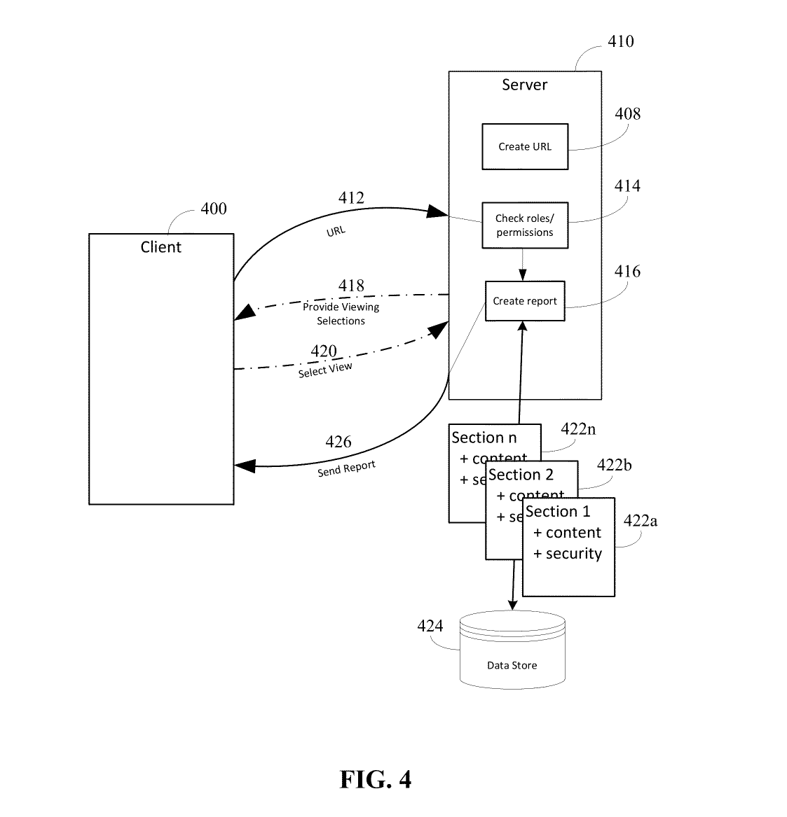

FIG. 4 shows a flow diagram illustrating aspects of a method of providing a report via a report link in accordance with an embodiment of the invention. Referring to FIG. 4, a client 400 (via an application running on the client) requests to view a report located at a URL (408) created by a report service server 410 by navigating (412) to coordinates specified by the URL. The URL may be generated to include an application server (name and port), a report name, and a GUID for the report identifier. In some embodiments, an output file type can be passed through the URL to indicate how the report is to be viewed (for example, via view selection 418, 420).

The server 410 performs a check of the roles/permissions (414) for a user accessing the server via the client 400, and creates a report view (416) according to the roles/permissions of the client. The report view can be created by combining sections of a report generated for a particular time frame.

In one embodiment, such as described with respect to FIG. 3, the server may respond to the initial request at the URL by presenting options (e.g., viewing selections 418) for a user to select a particular file type/format for the report view. In response to receiving a selected view 420, a personalized report can be created by the server according to the requested format (416). When creating the report view, the content of sections 422a, 422b, . . . , 422n corresponding to the roles/permissions of the user are obtained from the data store 424 in which the report is stored and arranged into a report of the appropriate format. The report is then output to the client (426) for viewing (and/or other actions indicated by the role/permissions of the user). When a user requests to view the report, the report is retrieved from the data store 424, formatted, and then returned to the user in the appropriate manner.

In another embodiment, when a user navigates (412) to coordinates specified by a URL and upon the server checking the roles/permissions (414) for the user, an initial report view (416) can be created and output to the client (426) in HTML. In response to a request from the user, viewing selections can be provided so that the user may select a particular format for the report (other than HTML).

In an embodiment, the server retrieves pieces of content that the user has permission to view from all the content available to the document; forms a personalized report from the permitted pieces of content; and sends the personalized report to the user for viewing.

Some embodiments are able to reduce consumption of computing resources used in generating multiple reports; storing multiple reports; and/or delivering multiple reports to a large number of people. Some embodiments are able to provide improved efficiency to a user such that a single report and link can be provided to any number of recipients and a personalized view of the report created for a recipient on-demand according to their assigned permissions and roles.

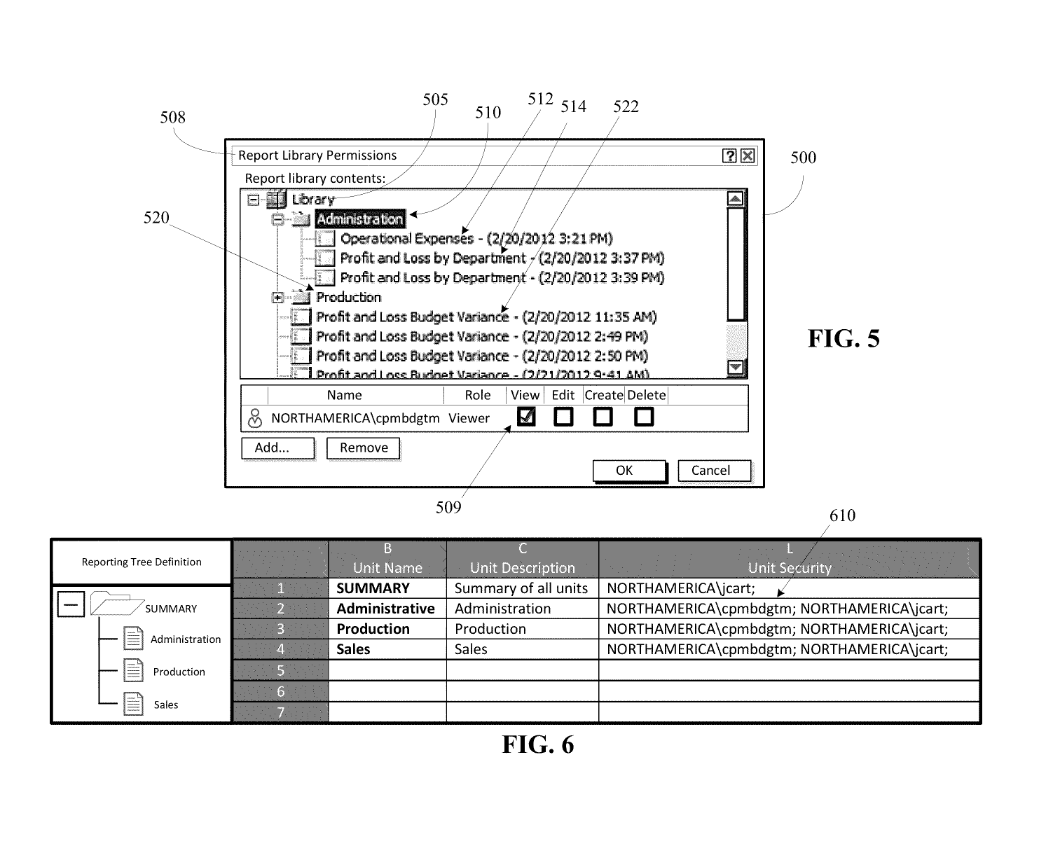

FIGS. 5-8 illustrate an example implementation in which a method of providing an on-demand personalized report is performed in accordance with embodiments of the invention.

Creating a report illustrates a snapshot of time, and a user of a reporting tool may need to create multiple repots to send to the various consumers. For example, Administration, Production, and Sales teams may need to see certain aspects of a report. According to an embodiment, a single report can be created and the viewer can receive a document on-demand that is personalized according to their assigned permissions. The server can check user credentials and generates a viewable report document according to those permissions upon the request to view the report. That is, the report is generated once and stored in a database. The report can then be accessed and a view of the report presented to a user based on their permissions and desired viewing format.

FIG. 5 shows a screen shot of permissions applied to a library of a report GUI 500. As shown in FIG. 5, a report Library 505 can include files and documents. Security settings (e.g., Report Library Permissions 508) may be configured (for example by a system administrator) on a per-user basis. In further embodiment, security permissions can be set according to folder level and/or document level within the Library. As shown in the example illustrated in FIG. 5, a Library 505 used in storing financial reports includes an Administration file 510 and a Production file 520. In the Administration file 510, documents including Operational Expenses 512 and Profit and Loss by Department 514 are shown. In the Production file 520, documents including Profit and Loss Budget Variance 522 are shown.

In the example, the Report Library Permissions 508 are used to control permissions of a user for contents of the Library. For example, the Administration folder 510 can have security permissions applied for user identifier “name” cpmbdgtm as view enabled by selecting a “view” check box 509. When such a security permission is applied, cpmbdgtm has permission to view the documents in the Administration folder. The permissions may be granted at various levels within the Library and can be applied to individuals and/or user groups or teams.

FIG. 6 illustrates permissions for units of a report according to an example embodiment. For the example report configuration, the report may include units of “Summary,” “Administrative,” “Production,” and “Sales.” The user cpmbdgtm 610 is shown to have access to the Administrative unit due, for example, to being granted permission in the report GUI 500 of FIG. 5.

In accordance with various embodiments of the invention, a URL link can be created for a particular report. The report link, for example “http://MyAppServer:4712:/report.svc/latest//” 702 shown in FIG. 7, may be distributed to a number of users through email, posted on a site that is part of a collaboration platform, and/or maintained in the Library of a reporting application.

Various scenarios for providing the report link can be implemented. In one scenario, the link can be emailed to anyone and each recipient can view only the portion of the report that they have permissions to view. Therefore, instead of creating separate reports and emailing a report document to particular recipients, the report view is dynamically created upon a user clicking on the report link. It should be understood that the dynamic creation is not directed to running a new report for the most recent data; rather, the dynamic creation is to configure the particular consumable view of the data from the report stored in a database to individual recipients upon their viewing of the report. In accordance with embodiments of the invention, recipients can select to view the report at different times and still see the same data.

When a report is initially generated and the report link created, the report link may be sent to users from within a native client, by email, or by publishing the link to an internal web page directory or to a specified directory on a network when the report is initially generated.

FIG. 7A shows an example screen of a page presented to a user after clicking on or entering the report link into a web browser application in accordance with an embodiment of the invention. Referring to FIG. 7A, a user may access a report using a client device such as tablet 700. After clicking on or entering the report link (e.g., http://MyAppServer:4712:/report.svc/latest//” 702) in a browser, a page 710 where an output type is selected can be displayed. The page 710 may present a menu of options for an output type.

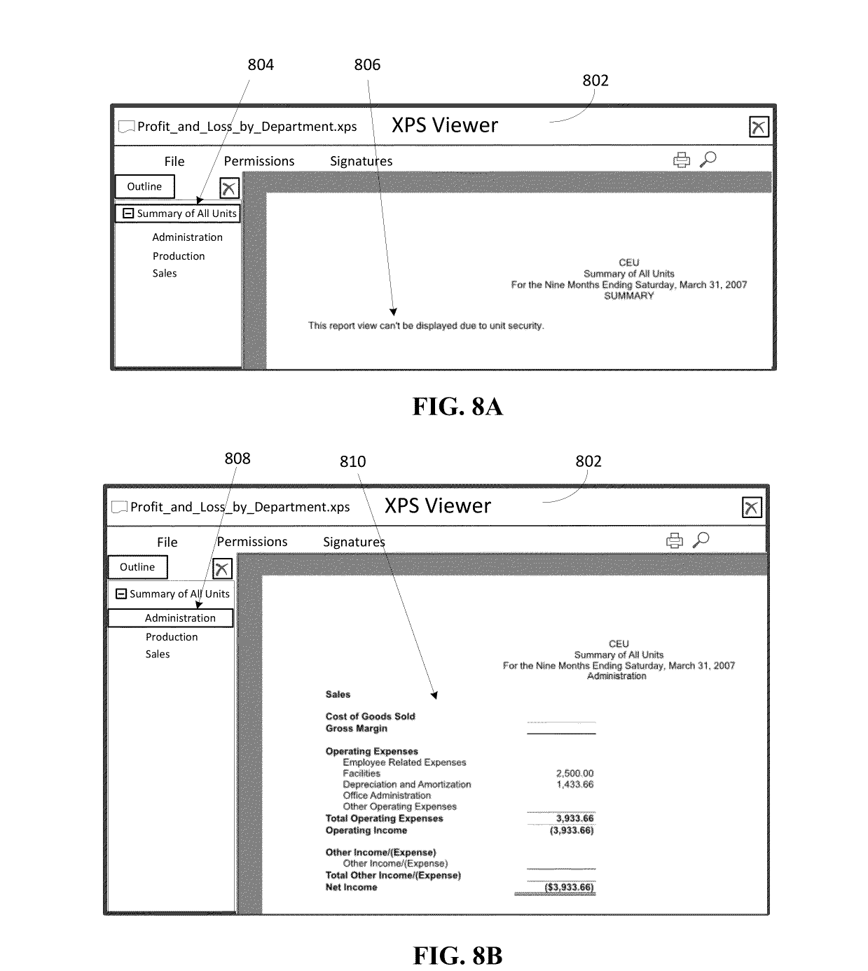

As described with respect to FIGS. 3 and 4, the report system can present options for a user to select a file type if the user is authenticated to access the report. In the example shown in FIG. 7A, a user may select to use a native viewer, a spreadsheet application or an XPS viewer 712, providing the user with flexibility as to how the report would be viewed. For the example, user cpmbdgtm may have received the report link and clicked on the link to access the report using her tablet 700. The page 710 for selecting a file type can be presented to user cpmbdgtm, and if she selects the XPS viewer option 712, the report view would be provided in XPS format. The client browser can receive the report view data and direct the data to an XPS viewer for display as shown in FIGS. 8A and 8B.

FIG. 7B shows an example screen of a page presented to a user after clicking on or entering the report link into a web browser application in accordance with another embodiment of the invention. Referring to FIG. 7B, instead of an intermediary page from which a user may select an output type, the report may be provided in HTML format in a “quick view” 720 upon clicking on or entering the report link in the browser.

From the “quick view” screen 720, the user may select to download the report view in a particular format. For example, user cpmbdgtm may have received the report link and clicked on the link to access the report using her tablet 700. A “quick view” of the report can be provided based on cpmbdgtm's permissions. From the screen having the “quick view”, user cpmbdgtm may select a menu option, such as “download” 722, which may open a window or menu 724 in which she may select a different report view type. For example, if she selects the XPS viewer option in the menu 724, the report view would be provided in XPS format. Similar to the embodiment shown in FIG. 7A, the client browser can receive the report view data and direct the data to an XPS viewer for display as shown in FIGS. 8A and 8B.

FIGS. 8A and 8B show a personalized view of a report that has been opened in the XPS viewer in accordance with an embodiment of the invention. The user has access only to the unit of the report they've been given access to when the report was designed. For example, as shown in FIG. 6, cpmbdgtm is given access to the Administration unit, but not the Summary. Therefore, as illustrated in FIG. 8A, when the report is presented in the XPS viewer 802 for the page associated with the “Summary of All Units” 804, cpmbdgtm's report does not include the unit for the Summary. In one embodiment, a message can be displayed indicating that “This report view can't be displayed due to unit security” 806.

In addition, because of the permissions for the Administration unit, when the report is presented in the XPS viewer 802 for the page associated with Administration 808, the report view 810 for the unit is displayed as shown in FIG. 8B.

Within a BI system, users may be granted permissions by an administrator with respect to the data and rights available for actions including viewing, creating modifying, publishing, and the like. When a user generates a report, for example, a financial report, the user may have certain data analysis user for more than one group or individual in the company.

Accordingly, a report, such as a financial report, can be distributed to many people through a report link and a personalized report view configured for each recipient according to their permissions. The reports can be sent to people inside and outside of company. In most embodiments, a person viewing the file is within the system in order to access the file, but embodiments are not limited thereto.

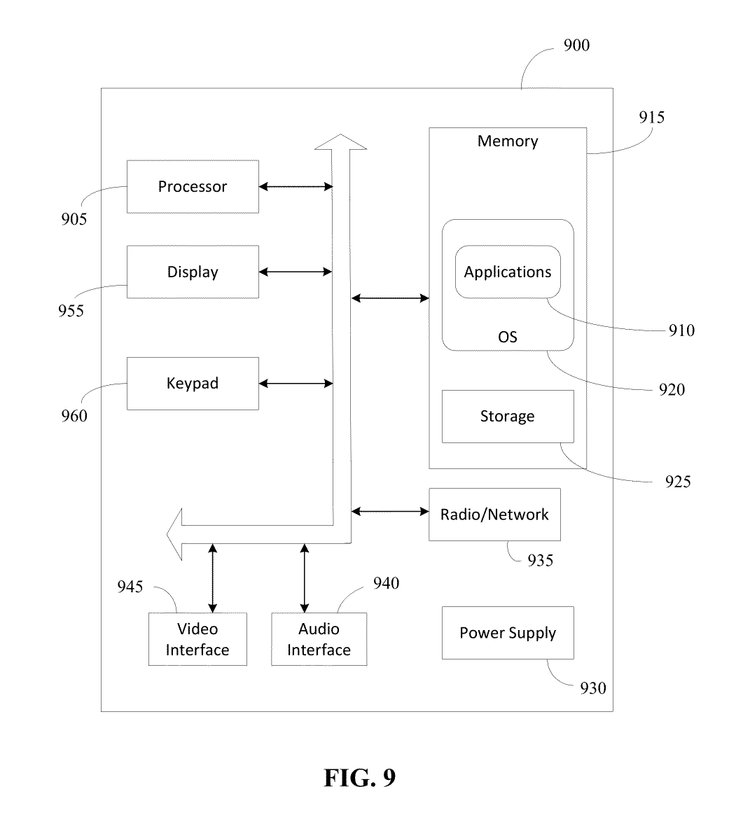

FIG. 9 shows a block diagram illustrating components of a computing device used in some embodiments. For example, system 900 can be used in implementing a server or a client device in the form of a desktop or notebook computer or a tablet or a smart phone that can run one or more applications. In some embodiments, system 900 is an integrated computing device, such as an integrated personal digital assistant (PDA) and wireless phone.

System 900 includes a processor 905 that processes data according to instructions of one or more application programs 910, and/or operating system 920. The one or more application programs 910 may be loaded into memory 915 and run on or in association with the operating system 920. Examples of application programs include phone dialer programs, web conferencing programs, e-mail programs, personal information management (PIM) programs, word processing programs, spreadsheet programs, Internet browser programs, messaging programs, game programs, and the like. Other applications may be loaded into memory 915 and run on the device, including various client and server applications.

System 900 also includes non-volatile storage 925 within memory 915. Non-volatile storage 925 may be used to store persistent information that should not be lost if system 900 is powered down. Application programs 910 may use and store information in non-volatile storage 925, such as e-mail or other messages used by an e-mail application, and the like. A synchronization application may also be included and reside as part of the application programs 910 for interacting with a corresponding synchronization application on a host computer system (such as a server) to keep the information stored in non-volatile storage 925 synchronized with corresponding information stored at the host computer system.

System 900 has a power supply 930, which may be implemented as one or more batteries and/or an energy harvester (ambient-radiation, photovoltaic, piezoelectric, thermoelectric, electrostatic, and the like). Power supply 930 might further include an external power source, such as an AC adapter or a powered docking cradle that supplements or recharges the batteries.

System 900 may also include a radio/network interface 935 that performs the function of transmitting and receiving radio frequency communications. The radio/network interface 935 facilitates wireless connectivity between system 900 and the “outside world,” via a communications carrier or service provider. Transmissions to and from the radio/network interface 935 are conducted under control of the operating system 920, which disseminates communications received by the radio/network interface 935 to application programs 910 and vice versa.

The radio/network interface 935 allows system 900 to communicate with other computing devices, such as over a network.

An audio interface 940 can be used to provide audible signals to and receive audible signals from the user. For example, the audio interface 940 can be coupled to speaker to provide audible output and a microphone to receive audible input, such as to facilitate a telephone conversation. System 900 may further include video interface 945 that enables an operation of an optional camera (not shown) to record still images, video stream, and the like. Visual output can be provided via a touch screen display 955. In some cases, the display may not be touch screen and user input elements, such as buttons, keys, roller wheel, and the like are used to select items displayed as part of a graphical user interface on the display 955. A keypad 960 can also be included for user input. The keypad 960 may be a physical keypad or a soft keypad generated on the touch screen display 955.

It should be understood the any mobile or desktop computing device implementing system 900 may have more or fewer features or functionality than described and is not limited to the configurations described herein.

In various implementations, data/information stored via the system 900 may include data caches stored locally on the device or the data may be stored on any number of storage media that may be accessed by the device via the radio/network interface 935 or via a wired connection between the device and a separate computing device associated with the device, for example, a server computer in a distributed computing network, such as the Internet. As should be appreciated such data/information may be accessed through the device via the radio interface 935 or a distributed computing network. Similarly, such data/information may be readily transferred between computing devices for storage and use according to well-known data/information transfer and storage means, including electronic mail and collaborative data/information sharing systems.

Certain techniques set forth herein may be described in the general context of computer-executable instructions, such as program modules, executed by one or more computing devices. Generally, program modules include routines, programs, objects, components, and data structures that perform particular tasks or implement particular abstract data types.

Embodiments may be implemented as a computer process, a computing system, or as an article of manufacture, such as a computer program product or computer-readable medium. Certain methods and processes described herein can be embodied as code and/or data, which may be stored on one or more computer-readable media. Certain embodiments of the invention contemplate the use of a machine in the form of a computer system within which a set of instructions, when executed, can cause the system to perform any one or more of the methodologies discussed above. Certain computer program products may be one or more computer-readable storage media readable by a computer system and encoding a computer program of instructions for executing a computer process.

In accordance with embodiments of the invention, computer-readable media can be any available computer-readable storage media or communication media that can be accessed by the computer system.

Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

By way of example, and not limitation, computer-readable storage media may include volatile and non-volatile, removable and non-removable media implemented in any method or technology for storage of information such as computer-readable instructions, data structures, program modules or other data. For example, a computer-readable storage medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data for use by a computer system. “Computer-readable storage media” should not be construed or interpreted to include any carrier waves or propagating signals.

In addition, the methods and processes described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware modules perform the methods and processes included within the hardware modules.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

1. A method of providing personalized reports, the method comprising
receiving a view report request from a user as a service call from the user to a report link to a web service file reference for a storage location of a complete report identified by the view report request;
determining security permissions of the user after receiving the view report request;
retrieving pieces of content from content available for the complete report identified by the view report request according to the security permissions of the user;
forming a personalized report from the pieces of content of the complete report; and
sending the personalized report to the user.

2. The method of claim 1, further comprising:
generating a latest report for the complete report using a business intelligence tool;
storing the latest report at the storage location; and
creating the report link to web service file reference for the storage location.

3. The method of claim 2, wherein creating the report link comprises generating a uniform resource locator (URL) comprising an application server name, a web service file, and a report identifier.

4. The method of claim 1, wherein each piece of content corresponds to a unit of the complete report, the retrieving of the pieces of content being performed on a per-unit basis to populate the personalized report with units to which the user is determined to have an appropriate security permission.

5. The method of claim 1, further comprising:
presenting the user with a menu for selecting an output type for viewing the personalized report after receiving the view report request from the user; and
in response to receiving a selected output type, sending the personalized report to the user in a format according to the selected output type.

6. The method of claim 5, wherein the output type comprises a spreadsheet file or an extended markup language (XML) paper specification (XPS) file.

7. The method of claim 5, further comprising:
processing the view report request by verifying that the user has access to view at least a portion of the complete report identified by the view report request before presenting the user with the menu for selecting the output type, wherein the determining of the security permissions of the user is performed after receiving the selected output type.

8. A computer-readable storage medium having instructions stored thereon that when executed perform a method comprising:
generating a latest report;
storing the latest report at a storage location;
creating a report link to a web service file reference for the storage location;
receiving a view report request from a user, wherein receiving the view report request from the user comprises receiving a service call from the user to the report link;
in response to receiving the service call to the report link, determining security permissions of the user and retrieving pieces of content from content available for a complete report of the latest report identified by the view report request according to the security permissions of the user;
forming a personalized report from the pieces of content of the latest report; and
sending the personalized report to the user.

9. The medium of claim 8, wherein creating the report link comprises generating a uniform resource locator (URL) comprising an application server name, a web service file, and a report identifier.

10. The medium of claim 8, wherein each piece of content corresponds to a unit of the complete report, the retrieving of the pieces of content being performed on a per-unit basis to populate the personalized report with units to which the user is determined to have an appropriate security permission.

11. The medium of claim 8, wherein the method further comprises:
presenting the user with a menu for selecting an output type for viewing the personalized report after receiving the view report request from the user; and
in response to receiving a selected output type, sending the personalized report to the user in a format according to the selected output type.

12. The medium of claim 11, wherein the output type comprises a spreadsheet file or an extended markup language (XML) paper specification (XPS) file.

13. The medium of claim 11, wherein the method further comprises:
processing the view report request by verifying that the user has access to view at least a portion of the complete report identified by the view report request before presenting the user with the menu for selecting the output type, wherein the determining of the security permissions of the user is performed after receiving the selected output type.

14. A method of providing personalized reports, the method comprising:
receiving a first service call from a first user to a file report link that includes a web service file reference;
generating a first personalized report document according to the first user's security permissions by piecing together units of a previously generated and stored report document to which the first user's security permissions indicate the first user has access;
outputting the first personalized report document to a first viewer;
receiving a second service call from a second user to the file report link that includes the web service file reference;
generating second personalized report document according to the second user's security permissions by piecing together units of the previously generated and stored report document to which the second user's security permissions indicate the second user has access; and
outputting the second personalized report document to a second viewer.

15. The method of claim 14,
wherein the first user and the second users have different security permissions so that the first personalized report document and the second personalized report document contain at least one difference.

16. (canceled)

17. The method of claim 14, wherein the report link comprises a uniform resource locator (URL) comprising an application server name, a web service file, and a report identifier.

18. The method of claim 14, wherein outputting the first personalized report document comprises:
sending the first personalized report document to the user in hypertext mark-up language (HTML).

19. The method of claim 18, further comprising:
after sending the first personalized report document to the user, providing the first user with a menu for selecting a secondary output type for the first personalized report document;
receiving a selected secondary output type for the first personalized report document; and
formatting the first personalized report document according to the selected output type.

20. The method of claim 19, wherein the secondary output type comprises a spreadsheet file or an extended markup language (XML) paper specification (XPS) file.

21. The method of claim 14, wherein every time a service call is received from the first user having the same security permissions as when the first service call was received, the personalized report document generated in response to the service call has the same content as first personalized report document.
